(19) United States
(12) Patent Application Publication
(10) Pub. No.: US 2025/0063633 A1
(43) Pub. Date: Feb. 20, 2025

(54) MOBILE DEVICE EMERGENCY MESSAGE HANDLING APPARATUS AND METHOD THEREFOR

(71) Applicant: RAPIDSOS, INC., New York, NY (US)

(72) Inventors: Plarent Tirana, New York, NY (US); Conor Fucci, New York, NY (US)

(21) Appl. No.: 18/805,518

(22) Filed: Aug. 14, 2024

Related U.S. Application Data
(60) Provisional application No. 63/533,157, filed on Aug. 17, 2023.

(51) Int. Cl. H04W 76/50; H04W 4/90

(52) U.S. Cl. CPC H04W 76/50; H04W 4/90

(57) ABSTRACT

A disclosed method of operating an emergency messaging system includes: receiving a data message at a cloud server in response to a mobile device sending an emergency message to an emergency network; determining by the cloud server that the emergency network is incapable of receiving the emergency message in response to receiving the data message; and initiating a messaging session between the mobile device and the emergency network comprising a first messaging session leg between the mobile device and the cloud server, and a second messaging leg between the cloud server and a browser executing on an emergency network entity of the emergency network.

### CROSS-REFERENCE TO RELATED APPLICATIONS

The present application claims priority to U.S. Provisional Patent Application No. 63/533,157, filed Aug. 17, 2023, entitled “MOBILE DEVICE EMERGENCY MESSAGING HANDLING APPARATUS AND METHOD THEREFOR” which is hereby incorporated by reference herein in its entirety, and which is assigned to the same assignee as the present application.

### FIELD OF THE DISCLOSURE

The present disclosure relates generally to emergency networks such as public safety answering points (PSAPs) and enhanced 911 and next generation 911 emergency networks and more particularly to methods and apparatuses for sending and receiving messages between mobile devices and PSAPs.

### BACKGROUND

Messaging applications are ubiquitous currently and most mobile device users engage with some type of short-message-service (SMS), multi-media message service (MMS) or other messaging applications that enable sending and receiving text messages. Emergency networks such as public safety answering points (PSAPs) accept emergency calls such as 9-1-1 calls and are currently continuing to evolve toward the capability to accept 9-1-1 emergency messages from SMS, MMS and other messaging applications. These messages are referred to as “text-to-911.” Not all emergency networks are currently able, or willing, to accommodate emergency messaging and therefore, if a user attempts to send an emergency 9-1-1 text message that is directed to an emergency network that is unable to accept the message, the user may be left in a dangerous situation without emergency assistance.

### BRIEF DESCRIPTION OF THE DRAWINGS

FIG. 1 is a diagram of an emergency messaging network in accordance with the embodiments.

FIG. 2 is a message flow diagram for an emergency messaging system in accordance with various embodiments.

FIG. 3 is another message flow diagram for an emergency messaging system in accordance with various embodiments.

FIG. 4 is a flowchart of a method of operation of an emergency messaging system in accordance with an embodiment.

FIG. 5 is an example graphical user interface (GUI) that provides a map view for an emergency network.

FIG. 6 is another example GUI displayed on an emergency network computing device display (such as a PSAP workstation display) in accordance with an embodiment.

FIG. 7 is another example GUI displayed on an emergency network computing device display (such as a PSAP workstation display) in accordance with an embodiment.

FIG. 8 is another example GUI displayed on an emergency network computing device display (such as a PSAP workstation display) in accordance with an embodiment.

FIG. 9 is a flowchart of a method of operation of an emergency messaging system in accordance with an embodiment.

FIG. 10 is a flowchart of a method of operation of an emergency messaging system in accordance with an embodiment.

FIG. 11 is a flowchart of a method of operation of an emergency messaging system in accordance with an embodiment.

FIG. 12 is a flowchart of a method of operation of an emergency messaging system in accordance with an embodiment.

### DETAILED DESCRIPTION

Briefly, the present disclosure enables an emergency network to receive and respond to emergency messages from a mobile device in cases where the emergency network is not otherwise capable of receiving emergency messages, by using a cloud-based application provided by a cloud server and executed in a browser as a portal GUI on an emergency network computing device such as a workstation.

One disclosed method of operating an emergency messaging system includes: receiving a data message at a cloud server in response to a mobile device sending an emergency message to an emergency network; determining by the cloud server that the emergency network is incapable of receiving the emergency message in response to receiving the data message; and initiating a messaging session between the mobile device and the emergency network comprising a first messaging session leg between the mobile device and the cloud server, and a second messaging leg between the cloud server and a browser executing on an emergency network entity of the emergency network.

The method may further include sending a notification from the cloud server to the browser that the mobile device sent the emergency message to the emergency network that the emergency network is incapable of receiving.

Another disclosed method includes: receiving a data message at a cloud server in response to a mobile device sending an emergency message to an emergency network; sending a notification from the cloud server, to an emergency network entity of the emergency network, that the mobile device sent the emergency message to the emergency network using a first messaging technology; and initiating a messaging session between the mobile device and the emergency network using a second messaging technology. The messaging session has a first messaging session leg between the mobile device and the cloud server, and a second messaging leg between the cloud server and a browser executing on an emergency network entity of the emergency network.

Another disclosed method includes: receiving a mobile device telephone number and a mobile device location from a mobile device at a cloud server in response to the mobile device sending an emergency message; determining by the cloud server that an emergency network is capable of receiving the emergency message; and initiating a messaging session between the mobile device and the emergency network. The messaging session has a first messaging session leg between the mobile device and the cloud server, and a second messaging leg between the cloud server and a browser executing on an emergency network entity of the emergency network.

Another disclosed method of operating an emergency messaging system includes: receiving a mobile device telephone number and location information at a cloud server via an internet connection in response to the mobile device initiating an emergency message; determining by the cloud server whether an emergency network is capable of receiving the emergency message; sending a notification to the mobile device that the emergency network is capable of receiving the message; and providing an instance of a cloud-based application to a computing device at the emergency network and providing the emergency message to the instance.

The method may further include determining that a bounce-back of the emergency message was received by the mobile device; and initiating an automatic emergency phone call by the mobile device in response to the bounce-back message. The method may further include communicating with a messaging application agent prior to initiating a messaging session between the mobile device and the instance of a cloud-based application at the emergency network. The method may further include initiating a timer at the cloud server prior to determining by the cloud server whether an emergency network is capable of receiving the emergency message. The method may further include initiating an automatic emergency phone call by the mobile device in response to the timer expiring prior to determining by the cloud server whether an emergency network is capable of receiving the emergency message. The method may further include initiating an automatic emergency phone call by the mobile device in response to the timer expiring prior to receiving a bounce-back of the emergency message by the mobile device.

Another disclosed method of operating an emergency messaging system, includes: receiving a mobile device telephone number and location information at a cloud server via an internet connection in response to the mobile device initiating an emergency message; determining by the cloud server that an emergency network is capable of receiving the emergency message; sending a notification to the mobile device that the emergency network is capable of receiving the message; and providing an instance of a cloud-based application to a computing device at the emergency network and providing a data message to the instance to initiate messaging communication between the mobile device and the instance.

The method may further include providing at least a portion of the emergency message within the data message. The method may further include providing the data message as a Short Message Peer-to-Peer (SMPP) message. The method may further include initiating SMPP messaging communication between the mobile device and the instance. Providing the data message may further include providing the instance of the cloud-based application to the computing device at the emergency network via a browser executed by the computing device. The method may further include determining that a bounce-back of the emergency message was received by the mobile device; and initiating an automatic emergency phone call by the mobile device in response to the bounce-back message. The method may further include communicating with a messaging application agent prior to initiating a messaging session between the mobile device and the instance of a cloud-based application at the emergency network. The method may further include initiating a timer at the cloud server prior to determining by the cloud server whether an emergency network is capable of receiving the emergency message. The method may further include initiating an automatic emergency phone call by the mobile device in response to the timer expiring prior to determining by the cloud server that an emergency network is capable of receiving the emergency message. The method may further include initiating an automatic emergency phone call by the mobile device in response to the timer expiring prior to receiving a bounce-back of the emergency message by the mobile device. Determining by the cloud server that an emergency network is capable of receiving the emergency message may include determining by the cloud server that an emergency network is not capable of receiving the emergency message via wireless network messaging infrastructure but is capable of receiving emergency messaging via the instance of the cloud-based application.

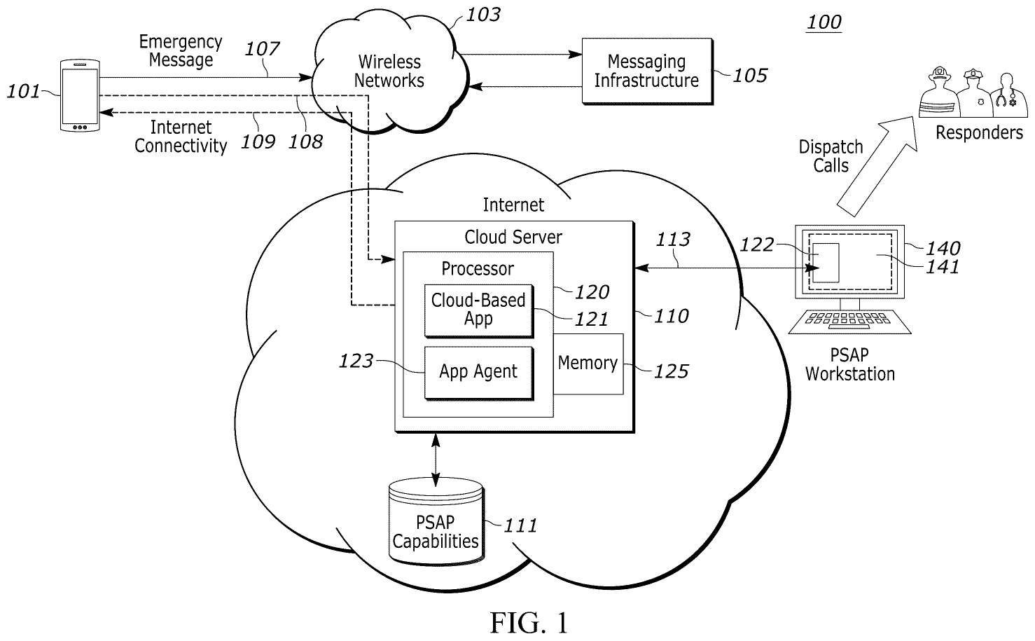

Turning now to the drawings wherein like numerals represent like components, FIG. 1 illustrates an emergency messaging network 100 in accordance with the embodiments. A mobile device 101 includes a messaging application such as a short-message-service (SMS), multi-media message service (MMS) or an over-the-top messaging application and is operative to send and receive text messages. The mobile device 101 may place an emergency message 107 by sending a text message to an emergency network via a 911 emergency number (or 112 or equivalent) using one of the aforementioned messaging applications. The emergency message 107 is transmitted via wireless networks 103 and a messaging infrastructure 105 which may include a text control center (TCC). The messaging infrastructure 105 may either transmit the message on to a PSAP or may send a bounce-back message that the emergency message 107 could not be transmitted to the destination PSAP.

In accordance with the various embodiments, when the mobile device 101 initiates an emergency message 107, it also sends its phone number and location information via message 108 to a cloud server 110 using internet connectivity. The message 108 may be, for example, an HTTP POST message. In some implementations, a check may be done to see if there is an active internet connection before sending an HTTP POST. If the internet connection is not available, an alternate method of sending the message may be employed such as text messaging, SMS binary messaging, etc. Alternatively, if an internet connection is not available, a 911 emergency call may be initiated if there is no response to the text message within a delay timer.

The cloud server 110 may send a response message 109 back to the messaging application of the mobile device 101, informing it that a PSAP is able to receive and respond to the mobile device 101 emergency message 107.

The cloud server 110 provides a cloud-based application 121, such as a software-as-a-service (SaaS) application to various PSAPs and an application agent 123 for communication with the messaging application executing on the mobile device 101. An emergency network computing device such as, for example, PSAP workstation 140 may execute an instance of the cloud-based application via a portal graphical user interface (GUI) 122 executing in a browser 141 with an internet connection 113 to the cloud server 110 and with connections to the cloud-based application 121. The cloud server 110 includes at least one processor 120, with an operatively coupled non-volatile, non-transitory memory 125 storing executable instructions (code) for the cloud-based application 121 and the application agent 123 such that the at least one processor 120 is operative to execute the executable instructions to provide the cloud-based application 121 and to provide at least one instance of the cloud-based application to a number of independent PSAPs via one or more portal GUIs 122 executing on one or more emergency network entities such as PSAP workstation 140. The at least one processor 120, by execution of the executable instruction in memory 125 is also operative to provide the application agent 123 to communicate with the mobile device 101 messaging application. The application agent 123 may be, in one example, Google Rich Business Messaging (RBM) agent, Apple Business Chat agent, (i.e. chat agents), or an equivalent, etc., that provides “real time message sessions” such as instant messaging (IM) and chat, in which all participants are online and receive and respond to immediate messages, and these messages provide a status indication, such as but not limited to an indication that a participant is typing, online, etc. Rich messaging also enables users to share interactive messages and attach high-resolution images, videos, voice messages, GIFs, etc. to enhance communication of information as compared to legacy SMS/MMS technology. The cloud server 110 is also operatively coupled to a PSAP capabilities database 111 which contains information regarding which PSAPs are capable of receiving emergency messages, which PSAPs are not capable of receiving emergency messages, and which PSAPs utilize the portal GUI 122 to receive and respond to emergency messages. The cloud-based application 121 provided by the cloud server 110 provides a text messaging capability via the portal GUI 122 for PSAPs that would not otherwise have the capability to receive and respond to emergency messages from mobile devices. This capability may be provided, for example, as a Short Message Peer-to-Peer (SMPP) messaging capability, or via a capability provided by an RBM agent or Apple Business Chat agent, or the equivalent, etc. when the application agent 123 is one of these as discussed above. By doing so, the cloud server 110 provides increased access and redundancy to emergency networks.

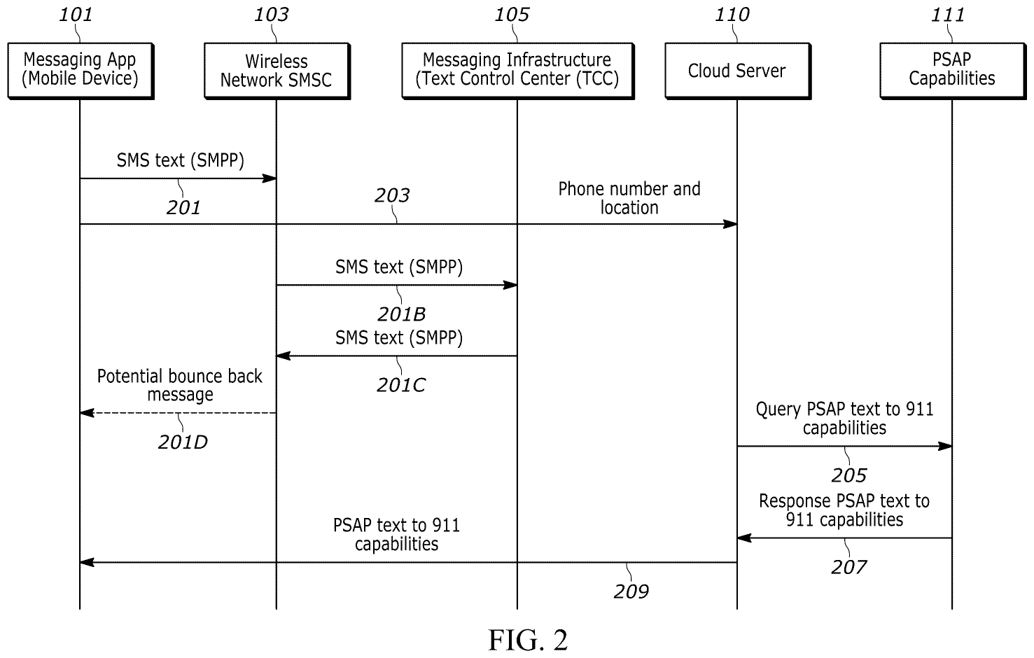

FIG. 2 is a message flow diagram for an emergency messaging system in accordance with various embodiments. When the mobile device 101 user places an emergency text message to 911 for example, the messaging application executing on the mobile device 101 sends an SMS text message 201 to the wireless network 103 short message service center (SMSC). The SMS text message 201 is a data message that may be, for example, a Short Message Peer-to-Peer (SMPP) message. SMPP is the telecommunications industry open standard protocol for providing a data communication interface for the transfer of short message data within the messaging infrastructure 105 (for example between External Short Messaging Entities (ESMEs), Routing Entities (REs) and an SMSC etc.). One advantage of using SMPP or chat agents is that it may be used for short message exchanges outside SS7 or C7 networks and therefore does not have to go through the wireless network 103 telephony infrastructure. The SMS text message 201 is forwarded on (SMS text message 201B) to the messaging infrastructure 105 (for example a text message control center (TCC) which may then respond with SMS text message 201C acknowledging the communication, or the wireless network 103 SMSC may send a bounce back message 201D indicating that the text message could not be transmitted.

At the time of initiation of the emergency text message to 911, the mobile device 101 also, via a separate emergency handling process within the mobile device 101, sends its phone number and location via data message 203 to the cloud server 110. In one example the data message 203 may be an HTTP POST message. In response to receiving this information, the cloud server 110 queries the PSAP capabilities database 111 for the pertinent emergency network, such as a PSAP, based on the location data, via query message 205. The location data may include mobile device-based hybrid location data generated by the mobile device 101 which may include GPS, triangulation or other calculated location in combination with GPS data etc. A query response message 207 is received that indicates that either: the PSAP is already capable of receiving text messages, the PSAP is not capable of receiving text messages, or that the PSAP is not capable of receiving text messages but has the portal GUI 122 capability to receive text messages. More particularly, the PSAP may not support SMS text messaging via the messaging infrastructure 105 and the SS7 telephone system (or C7 in the 112 emergency call system). However, the PSAP may be able to communicate with devices using Short Message Peer-to-Peer (SMPP) messages, or chat agent messages, with IP TCP by using the portal GUI 122 capability if the PSAP is using the cloud-based application 121 provided by the cloud server 110. The cloud server 110, via the application agent 123, communicates this capability information to the mobile device 101 messaging application via PSAP text to 911 capabilities message 209. The term “emergency message” as used herein may therefore refer to text-to-911 messages using SMS via telephony messaging infrastructure (such as messaging infrastructure 105 shown in FIG. 1) and SS7 or C7 signaling coordinated with the wireless networks 103, or may refer to SMPP messages using IP TCP, or chat messages, via the cloud-based application 121 provided by the cloud server 110 and the application agent 123.

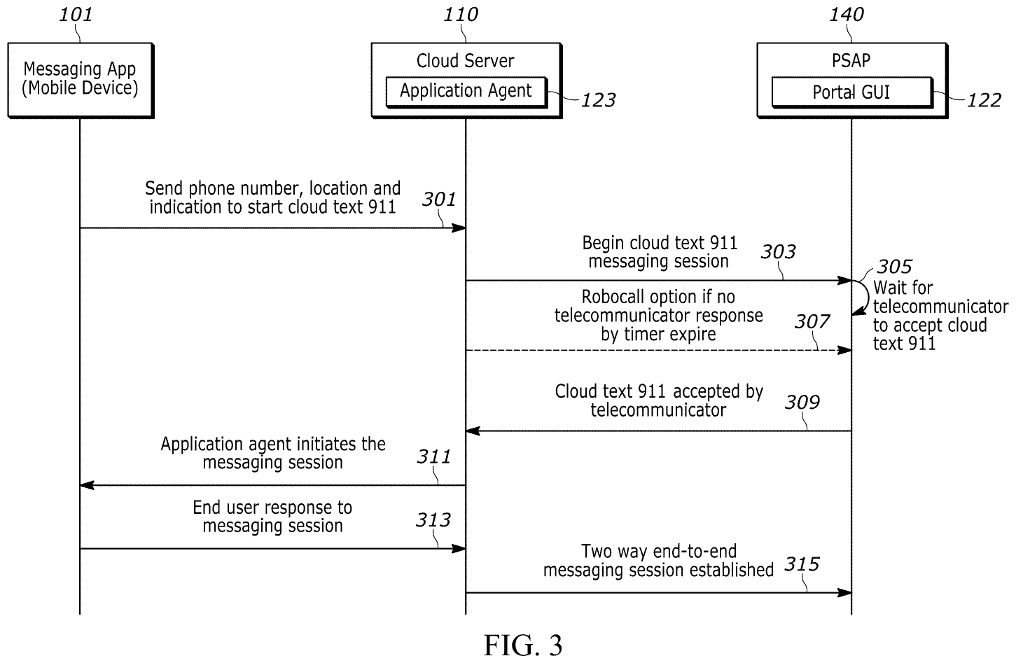

FIG. 3 is a message flow diagram for an emergency messaging system in accordance with various embodiments that provide further details on interchange between the portal GUI 122 at the PSAP, the cloud server 110 and the messaging application on the mobile device 101. The messaging application of the mobile device 101 may be used to send an emergency message as discussed above and this emergency message may be a text-to-911 message. In that case, the mobile device 101 will also send message 301 to the cloud server 110 containing the mobile device 101 telephone number and its location. In message 303, the application agent 123 will then begin the messaging session with the portal GUI 122, executing in a browser 141 of a PSAP workstation 140.

The application agent 123, at 305 waits for a telecommunicator (i.e. a PSAP workstation 140 operator, such as a call handler or dispatcher) to accept the cloud server 110 911 messaging. If a reject input is received by the portal GUI 122, or if no response is received within a timer period, then at 307 the application agent 123 may communicate with the mobile device 101 to initiate a 911 robocall.

If an “accept” input is received at the portal GUI 122, the portal GUI 122 will send message 309 to the cloud-based application 121 at the cloud server 110, the application agent 123 will send message 311 to the messaging application of the mobile device 101 to initiate the messaging session. The user will receive a notification on the mobile device 101 and have the capability via the mobile device 101 GUI to respond to initiate the messaging session. If the user responds, then message 315 is sent by the cloud server 110 to the portal GUI 122 and the telecommunicator may begin to message with the mobile device 101 user.

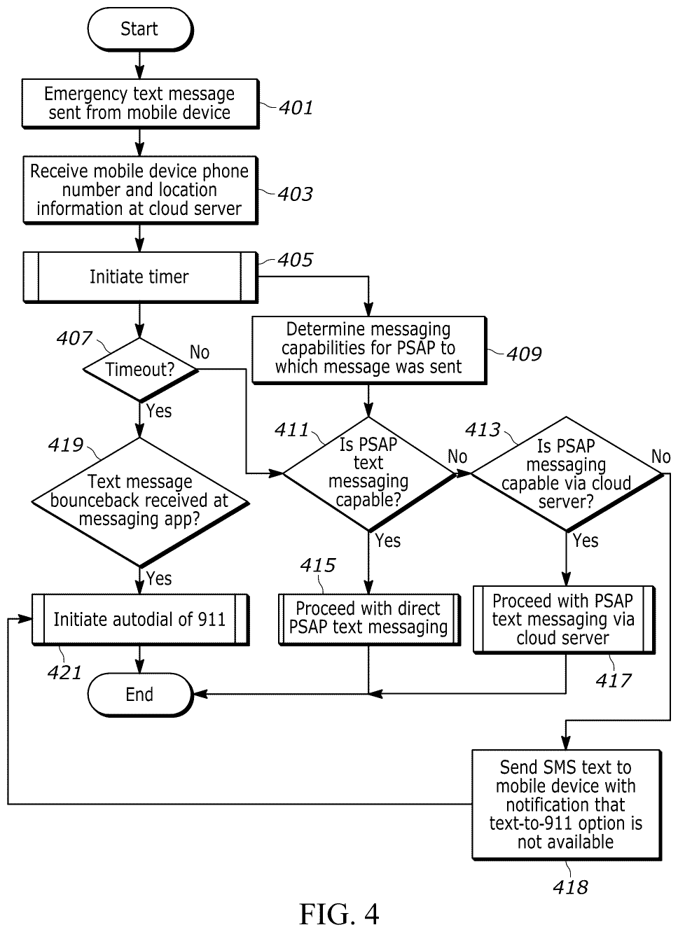

FIG. 4 is a flowchart of a method of operation of an emergency messaging system in accordance with an embodiment. The method of operation begins when the mobile device 101 sends an emergency text message in operation 401. In operation 403, the cloud server 110 receives the mobile device 101 phone number and location. This information is pushed to an emergency queue at the PSAP and is displayed in the portal GUI 122 at the PSAP, even if the PSAP is not able to receive the emergency message for some reason. A timer is initiated at operation 405 and the cloud server 110 determines the PSAP capabilities in operation 409. If the PSAP is found to have emergency messaging capability at decision 411, such that the PSAP can receive the emergency message, then the cloud server 110 will send a message to the messaging application of the mobile device 101 and direct text messaging may continue in operation 415 and the method ends. The determination operation 409 refers to text messaging capability via the wireless network 103 SMSC and the messaging infrastructure 105 TCC. More particularly, if the PSAP is text messaging capable then this approach will be used rather than the portal GUI 122 messaging capability.

However, if the PSAP is found not to be capable of receiving emergency messages at operation 409 and decision 411, then at decision 413 the cloud server 110 will check if the PSAP is messaging capable via the portal GUI 122 (i.e. that the PSAP uses the cloud-based application 121 and has the portal GUI 122 such that it can communicate via emergency messages. If the PSAP is using the portal GUI 122, then at operation 417 the cloud server 110 will send a message to the mobile device 101 messaging application and text messaging may proceed with the PSAP via the portal GUI 122 and the method ends.

However, if the PSAP is not capable of receiving text messages or does not use the portal GUI 122 for that purpose, the cloud server 110 will send a message to the messaging application of the mobile device 101 and the mobile device 101 will automatically initiate an emergency call by dialing 911 at operation 421 and the method ends. If the text messaging infrastructure or wireless network 103 SMSC sends a bounce-back message at decision 419, and the timer expires at decision 407, but prior to any of the above operations being completed, the mobile device 101 will also in this case automatically initiate an emergency call by dialing 911 at operation 421 and the method ends.

At decision 411 and decision 413, the message sent by the cloud server 110 to the mobile device 101 may be considered to be a data message or a notification that the PSAP is either capable, or not capable, of receiving the emergency message and responding. More particularly, at decision 411 the PSAP may not support SMS text messaging via the messaging infrastructure 105, and at decision 413 the PSAP may not be able to communicate with devices using Short Message Peer-to-Peer (SMPP) or chat messages if that particular PSAP does not use the portal GUI 122 capability provided by the cloud-based application 121 and the cloud server 110. In that situation, at operation 418, the cloud server 110, via the application agent 123, may send an SMS text notification to the mobile device 101 with a notification that a text-to-911 option is not available. The messaging application, at operation 421, upon receipt of the data message or notification that the PSAP is not capable of emergency messaging, may invoke the automatic dialing of 911 using the native dialer of the mobile device 101.

In some implementations, there may be an additional verification step before the autodialing 911 function to reduce the chance of misdials (or “butt dials”) or false alarms. For example, a user of the mobile device 101 may be prompted on the mobile device 101 user interface to confirm that there is an emergency (and/or emergency location) and if the user wishes to call 911. Also, a second timer may be initiated to provide time for the mobile device 101 user to respond to the prompt. During the second timer interval, the user may cancel the emergency or confirm the emergency to initiate the 911 call.

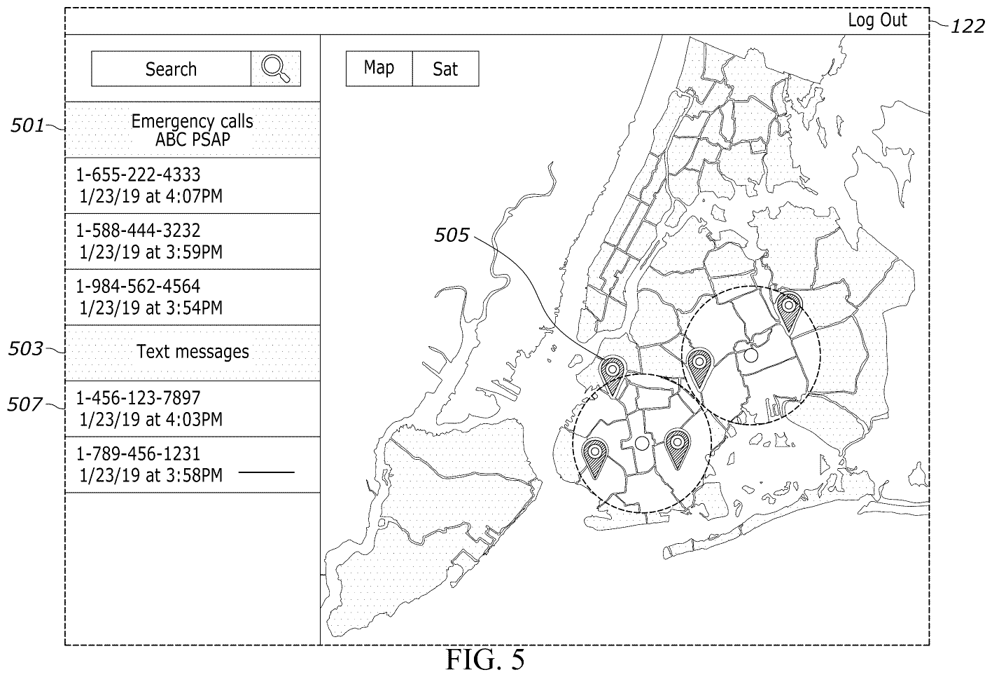

FIG. 5 provides one example of the portal GUI 122 showing a map view. The portal GUI 122 includes a list of incidents, i.e. an emergency call queue 501 corresponding to 911 emergency calls placed by mobile devices with corresponding location indicators 505 shown in a map view section. An emergency text messages queue 503 also shows entries with telephone numbers for emergency text messages that were sent from mobile devices. These emergency texts will also have a corresponding location indicator 505 shown in the map view. The emergency text messages queue 503 shows emergency text messages that were sent regardless of whether or not the particular PSAP is capable of receiving the emergency text message.

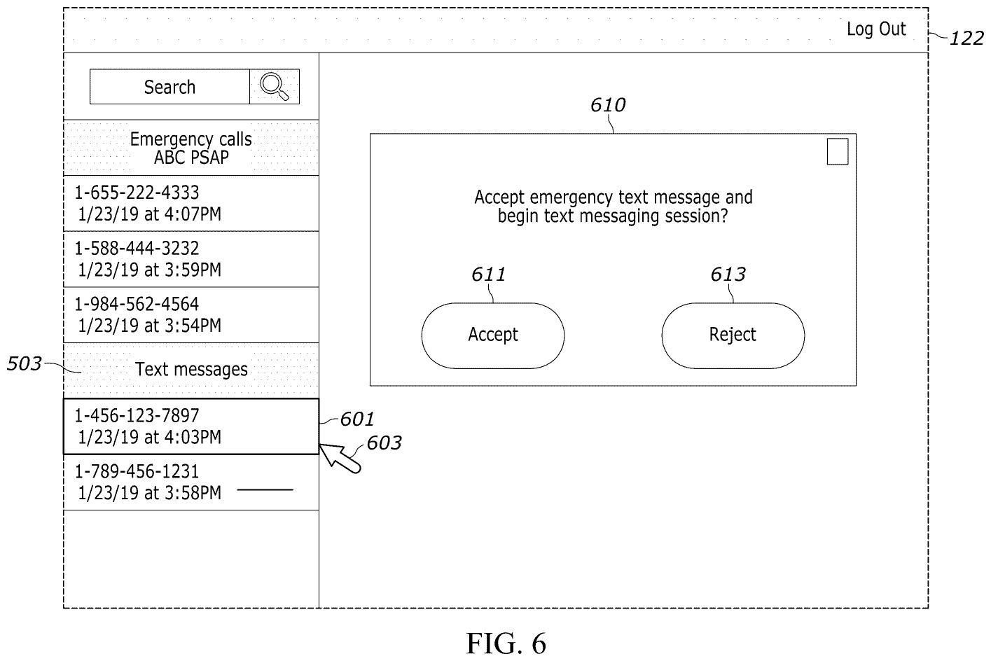

Emergency text messages may be “accepted” by a staff member (telecommunicator, call handler, dispatcher, etc.) by hovering a mouse cursor 603 over an entry in the emergency text messages queue 503 and making a selection. In the example of FIG. 6, the telecommunicator has selected entry 601. In response to the selection entry, a dialogue box 610 appears prompting the telecommunicator to accept the text message by selecting “ACCEPT” soft button 611 or to reject the text message by selecting “REJECT” soft button 613. As discussed above with respect to FIG. 3, the selection input by the telecommunicator causes the portal GUI 122 to send message 309 to the cloud-based application 121 at the cloud server 110, and the application agent 123 will send message 311 to the messaging application of the mobile device 101 to initiate the messaging session.

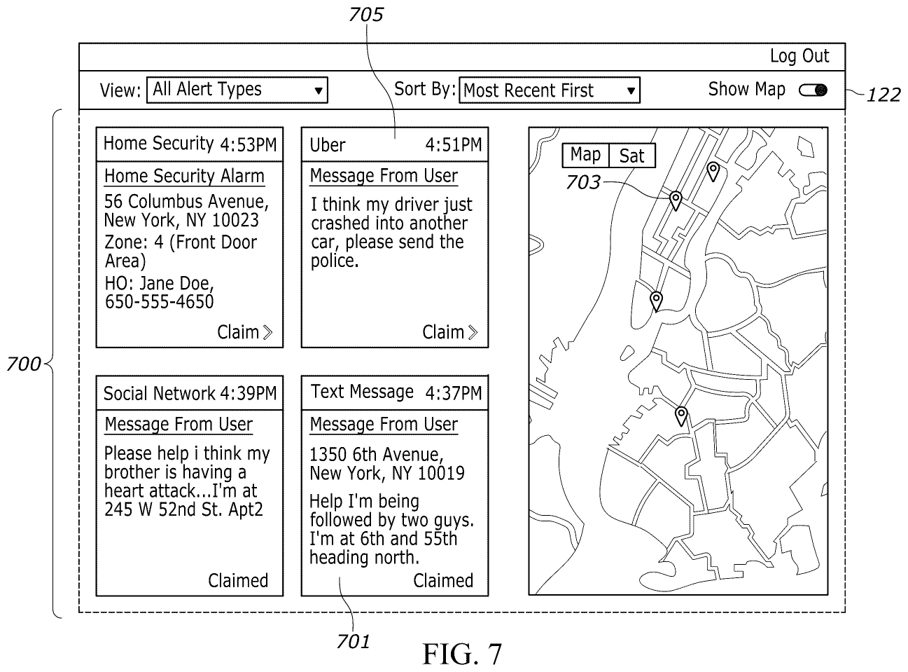

FIG. 7 is another example screen of the portal GUI 122 in which various details may be displayed on a message portion 700 with a map portion showing location indicators 703 for text messages in the message portion 700. In the example message 701, a mobile device user is asking for police assistance due to being followed by two suspicious characters. The indication “claimed” shows that the emergency text message has already been handled (i.e. “accepted”) by either the PSAP operator viewing the message, or by another PSAP operator. Thus, if the emergency text message is claimed by another operator, no further action is required and the present operator can proceed to handle other emergencies.

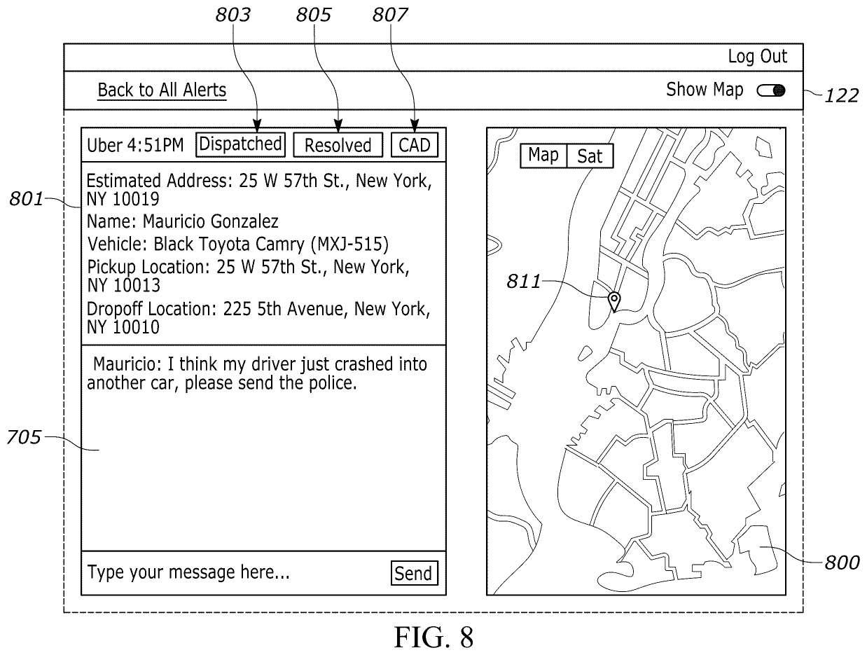

After a PSAP operator claims one of the messages, more information can be obtained by clicking the mouse cursor on the message box to make a selection of that particular message box. For example, by selecting the message 705, the portal GUI 122 provides the view in FIG. 8. The sole location indicator 811 is then shown on the map portion 800 and the message 705 is displayed on the left-hand side below other location information 801. The PSAP operator may appropriately select a disposition for the emergency by selecting one of the soft buttons labeled “Dispatched” 803, “Resolved” 805 or “CAD” (computer aided dispatch) 807 to send the item to a PSAP CAD operator. The current operator may also respond to the text message. Selecting “Back to All Alerts” would return to the previous portal GUI 122 view shown in FIG. 7.

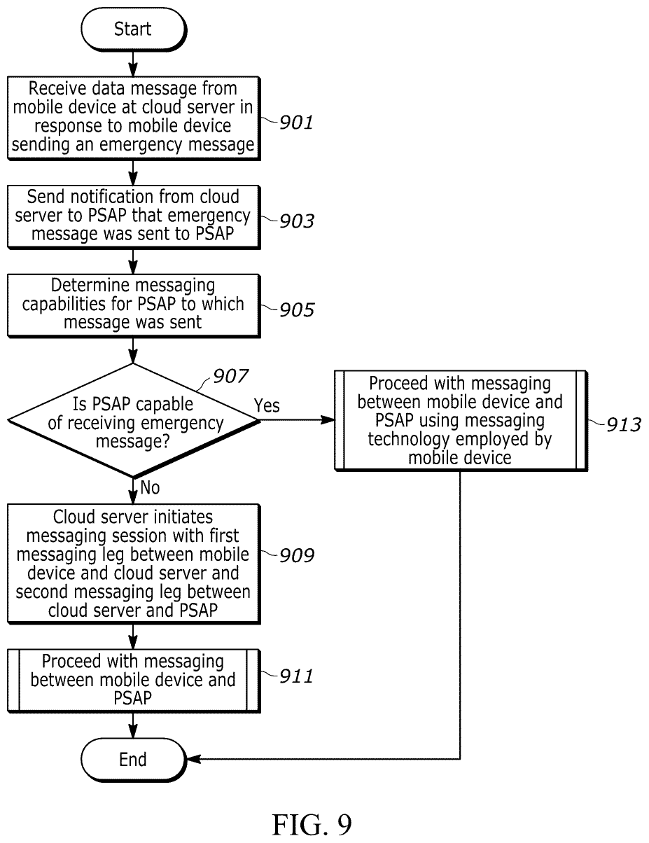

FIG. 9 is a flowchart of a method of operation of an emergency messaging session in accordance with an embodiment. At operation 901 the cloud server 110 receives a data message 108 from the mobile device 101 in response to the mobile device 101 sending an emergency message to the PSAP. The data message 108 may be, for example, an HTTP POST message and includes a mobile device identifier (such as the mobile device telephone number) and a mobile device location such as mobile device-based hybrid location data generated by the mobile device 101 which may include GPS, triangulation or other calculated location in combination with GPS data etc. At operation 903, the cloud server 110 sends a notification to the PSAP, by sending the notification to a PSAP entity (i.e. an emergency network entity) such as to PSAP workstation 140. The notification is sent to a browser, executing on the PSAP workstation 140, to provide an instance of the cloud-based application 121 via the portal GUI 122. The notification populates an emergency message queue such as example emergency text message queue 503 shown in FIG. 5. At operation 905, the cloud server 110 determines whether the PSAP has the technical capability to receive the emergency message. The cloud server 110 has awareness of the PSAP to which the emergency message would be routed, based the mobile device location that the cloud server 110 received in the data message 108, and knowledge of PSAPs servicing the area that includes the mobile device location. The cloud server 110 may determine the PSAP technical capabilities by performing a lookup operation using PSAP capabilities database 111. At decision 907, if the PSAP is cable of receiving the emergency message, the cloud server 110 may cease further action such that at operation 913 messaging proceeds using the messaging technology that was employed by the mobile device 101. However, if at decision 907 the PSAP is found unable to receive the emergency message, then at operation 909 the cloud server 110 initiates a messaging session between the mobile device 101 and the PSAP with a first messaging leg between the mobile device 101 and the cloud server 110, and a second messaging leg between the cloud server 110 and a PSAP network entity such as the PSAP workstation 140. At operation 911 messaging proceeds between the mobile device 101 user and the PSAP workstation 140 operator.

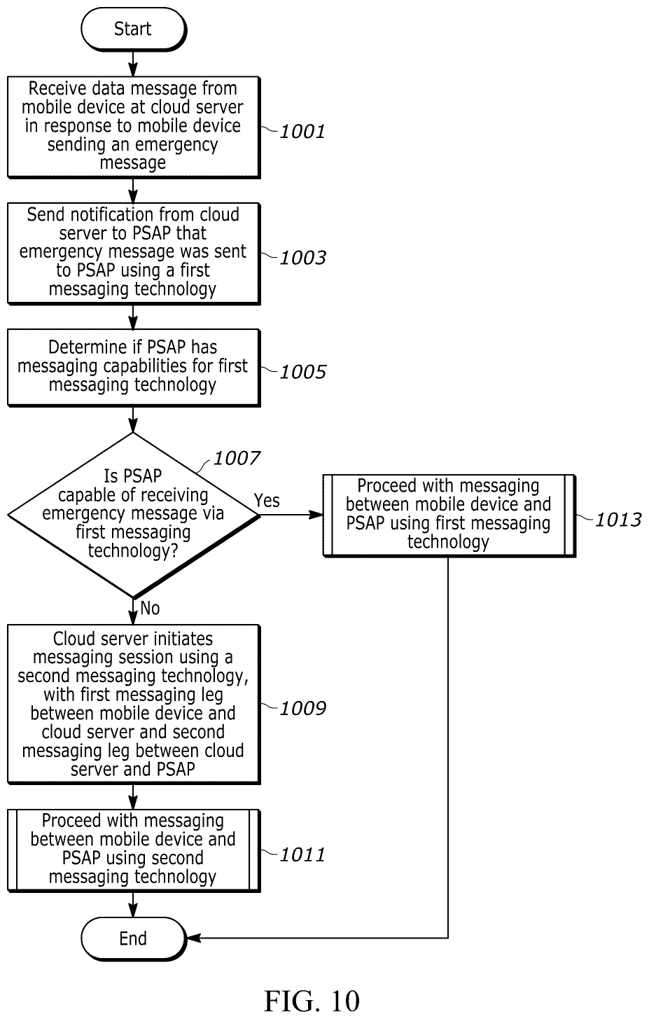

Turning to the flowchart of FIG. 10, at operation 1001, the cloud server 110 receives the data message 108 from the mobile device 101 in response to the mobile device 101 sending an emergency message. At operation 1003, the cloud server 110 sends the data message 108 to the PSAP workstation 140 when the mobile device 101 sends an emergency message using a first messaging technology. For example, the first messaging technology may be SMS, MMS, etc. At operation 1005, the cloud server 110 determines if the PSAP is capable of receiving the emergency message using the first messaging technology. If yes as decision 1007, then at operation 1013 messaging proceeds between the mobile device 101 and the PSAP. If no at decision 1007, then at operation 1009 the cloud server 110 initiates a messaging session using a second messaging technology with a first messaging leg between the mobile device 101 and the cloud server 110, and a second messaging leg between the cloud server 110 and the PSAP workstation 140. Messaging then proceeds as in operation 1011 using the second messaging technology. The second messaging technology may be facilitated by the application agent 123 which may be a chat agent such as an RBM agent, Apple Business Chat agent, or the like, etc.

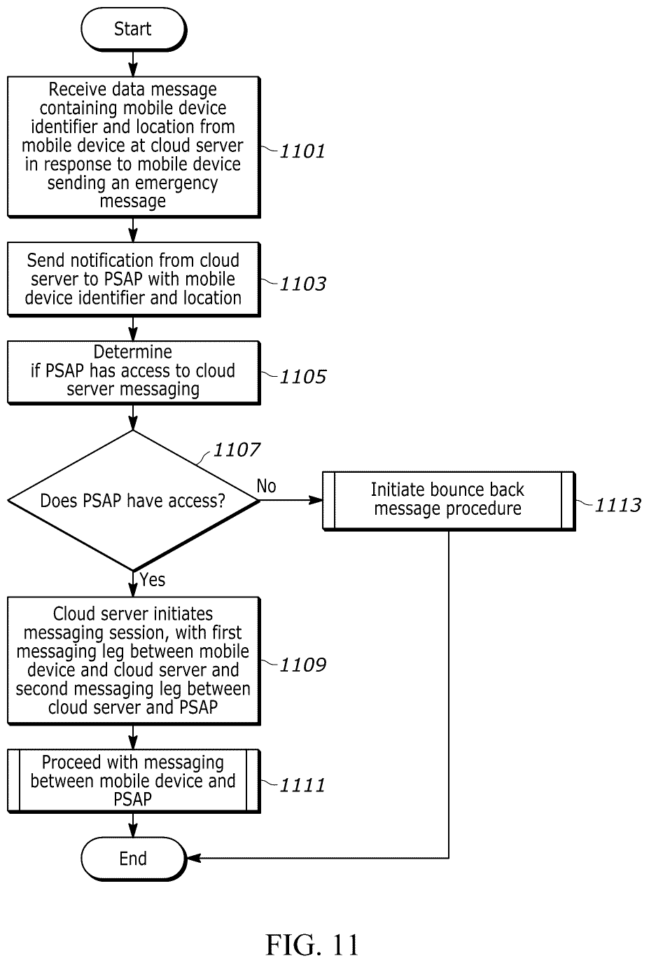

Turning to the flowchart of FIG. 11, at operation 1101 the cloud server 110 receives a mobile device identifier (IMSI, TMSI, mobile telephone number, or the like) and a mobile device location from the mobile device 101 in response the mobile device 101 sending an emergency message. At operation 1103 a notification is sent to the PSAP workstation 140 portal GUI 122 by way of the browser 141 and the mobile device identifier is displayed in a messaging queue such as, for example, emergency text messages queue 503. At operation 1105, the cloud server 110 determines if the PSAP has access to the cloud-based application 121. This may be accomplished by the cloud-based application 121 having an open session with the browser 141 such that emergency messages may be displayed in the portal GUI 122. If the PSAP does not have access at decision 1107 then in operation 1113 a bounce back message procedure may be initiated to the mobile device 101 and a notification may be provided informing the mobile device 101 that the emergency message cannot be delivered. However, if the PSAP does have access at decision 1107 then at operation 1109 the cloud server 110 initiates a messaging session with a first messaging leg between the mobile device 101 and a second messaging leg between the cloud server 110 and the PSAP workstation 140, by way of a cloud-based application 121 instance executing using the browser 141 and portal GUI 122. At operation 1111 messaging between the mobile device 101 and the PSAP proceeds accordingly.

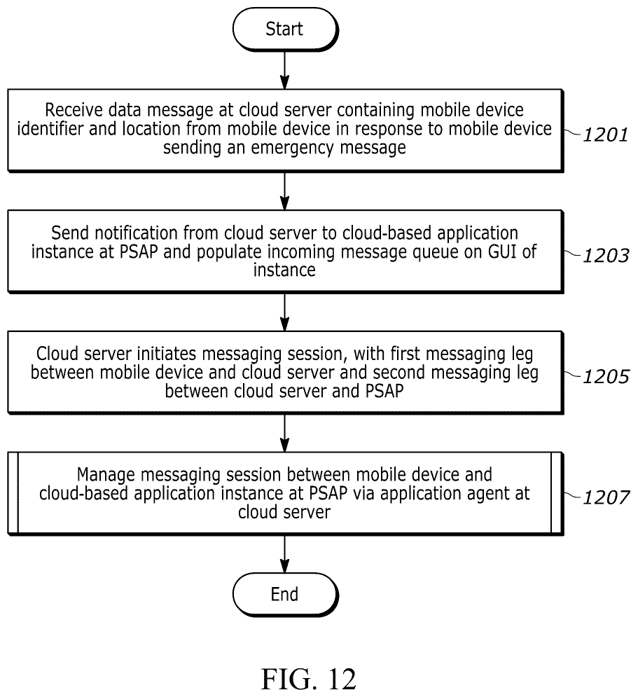

The flowchart of FIG. 12 shows the method of operation of the emergency messaging system with respect to operation of the application agent 123 and the portal GUI 122. At operation 1201 the cloud server 110 receives the data message 108 containing the mobile device identifier and mobile device location from the mobile device 101 in response to the mobile device 101 sending an emergency message. At operation 1203 the cloud server 110, by way of the cloud-based application 121, sends notification to the cloud-based application instance executing within browser 141 and populates an emergency message queue within the portal GUI 122 with the mobile device 101 identifier. The mobile device location may also be shown in the queue. At operation 1205 the cloud server 110 initiates a messaging session with a first messaging leg between the mobile device 101 and the cloud server 110, and a second messaging leg between the cloud server and the cloud-based application instance at the PSAP using the portal GUI 122. At operation 1207 the application agent 123 manages the messaging section between the mobile device 101 and the cloud-based application 121 instance at the PSAP.

The first messaging leg and the second messaging leg are facilitated using network connections such as IP connections from the mobile device 101 and between the PSAP workstation 140 and the cloud server 110. By using network connectivity by the emergency messaging system, the mobile device 101 may send and receive emergency messages to a PSAP even when the PSAP may not support telecommunication system based messaging (such as SMS, MMS, etc.), or when telecommunications based messaging systems are down (such as due to a natural disaster, network outage, etc.).

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
receiving a data message at a cloud server in response to a mobile device sending an emergency message to an emergency network;
determining by the cloud server that the emergency network is incapable of receiving the emergency message in response to receiving the data message; and
initiating a messaging session between the mobile device and the emergency network comprising a first messaging session leg between the mobile device and the cloud server, and a second messaging leg between the cloud server and a browser executing on an emergency network entity of the emergency network.

2. The method of claim 1, further comprising:
sending a notification from the cloud server to the browser that the mobile device sent the emergency message to the emergency network that the emergency network is incapable of receiving.

3. The method of claim 1, further comprising:
sending a notification comprising identification information for the mobile device, wherein the data message comprises the identification information.

4. The method of claim 1, further comprising:
sending a notification comprising a mobile device telephone number and a mobile device location, wherein the data message comprises the mobile device telephone number and the mobile device location.

5. The method of claim 1, wherein determining by the cloud server that the emergency network is incapable of receiving the emergency message, comprises:
determining that the emergency network is incapable of receiving the emergency messages using a messaging technology utilized by the mobile device.

6. The method of claim 1, wherein determining by the cloud server that the emergency network is incapable of receiving the emergency message, comprises:
determining that the emergency network is incapable of receiving the emergency messages using short-message-service (SMS) technology utilized by the mobile device.

7. The method of claim 1, wherein determining by the cloud server that the emergency network is incapable of receiving the emergency message, comprises:
determining that the emergency network is incapable of receiving the emergency messages using multi-media-messaging-service (MMS) technology utilized by the mobile device.

8. The method of claim 1, wherein determining by the cloud server that the emergency network is incapable of receiving the emergency message, comprises:
determining that the emergency network is incapable of receiving the emergency messages using short-message-peer-to-peer (SMPP) technology utilized by the mobile device.

9. The method of claim 1, further comprising:
providing, by the cloud server, a cloud-based application to the emergency network entity via the browser; and
providing the emergency messaging session via the cloud-based application within the browser.

10. The method of claim 8, further comprising:
sending a notification to a cloud-based application within the browser that the mobile device sent the emergency message to the emergency network that the emergency network is incapable of receiving.

11. The method of claim 1, further comprising:
sending a notification to the mobile device that the emergency network is incapable of receiving the message using a messaging technology utilized by the mobile device in sending the emergency message.

12. A method comprising:
receiving a data message at a cloud server in response to a mobile device sending an emergency message to an emergency network;
sending a notification from the cloud server, to an emergency network entity of the emergency network, that the mobile device sent the emergency message to the emergency network using a first messaging technology; and
initiating a messaging session between the mobile device and the emergency network using a second messaging technology, the messaging session comprising a first messaging session leg between the mobile device and the cloud server, and a second messaging leg between the cloud server and a browser executing on an emergency network entity of the emergency network.

13. The method of claim 12, wherein sending the notification comprises:
sending the notification from the cloud server to the emergency network entity of the emergency network when the mobile device sent the emergency message to the emergency network using the first messaging technology that the emergency network is incapable of receiving.

14. The method of claim 12, further comprising:
sending the notification comprising a mobile device telephone number and mobile device location, wherein the data message comprises the mobile device telephone number and the mobile device location.

15. The method of claim 12, further comprising:
determining that the emergency network is incapable of receiving the emergency messages using a messaging technology utilized by the mobile device.

16. The method of claim 12, wherein determining by the cloud server that the emergency network is incapable of receiving the emergency message, comprises:
determining that the emergency network is incapable of receiving the emergency messages using short-message-service (SMS) technology utilized by the mobile device.

17. The method of claim 12, further comprising:
providing, by the cloud server, a cloud-based application to the emergency network entity via the browser; and
providing the emergency messaging session via the cloud-based application within the browser.

18. A method of operating an emergency messaging system, the method comprising:
receiving a mobile device telephone number and a mobile device location from a mobile device at a cloud server in response to the mobile device sending an emergency message;
determining by the cloud server that an emergency network is capable of receiving the emergency message; and
initiating a messaging session between the mobile device and the emergency network, the messaging session comprising a first messaging session leg between the mobile device and the cloud server, and a second messaging leg between the cloud server and a browser executing on an emergency network entity of the emergency network.

19. The method of claim 18, further comprising:
sending a notification to the emergency network entity comprising the mobile device telephone number and the mobile device location.

20. The method of claim 18, further comprising:
initiating a timer at the cloud server prior to determining by the cloud server that the emergency network is capable of receiving the emergency message.
